(19) United States
(12) Patent Application Publication
(10) Pub. No.: US 2025/0036960 A1
(43) Pub. Date: Jan. 30, 2025

(54) TRUST RELATED MANAGEMENT OF ARTIFICIAL INTELLIGENCE OR MACHINE LEARNING PIPELINES IN RELATION TO ADVERSARIAL ROBUSTNESS

(71) Applicant: Nokia Technologies Oy, Espoo (FI)

(72) Inventors: Tejas SUBRAMANYA, Munich (DE); Janne ALI-TOLPPA, Espoo (FI)

(21) Appl. No.: 18/706,976

(22) PCT Filed: Nov. 9, 2021
(86) PCT No.: PCT/EP2021/081004

§ 371 Date: May 2, 2024

(51) Int. Cl. G06N 3/094; G06F 21/55

(52) U.S. Cl. CPC G06N 3/094; G06F 21/552; G06F 2221/033

(57) ABSTRACT

There are provided measures for trust related management of artificial intelligence or machine learning pipelines in relation to adversarial robustness. Such measures exemplarily comprise, at a first network entity managing artificial intelligence or machine learning trustworthiness in a network, transmitting a first artificial intelligence or machine learning trustworthiness related message towards a second network entity managing artificial intelligence or machine learning trustworthiness in an artificial intelligence or machine learning pipeline in said network, and receiving a second artificial intelligence or machine learning trustworthiness related message from said second network entity, wherein said first artificial intelligence or machine learning trustworthiness related message is related to artificial intelligence or machine learning model adversarial robustness as a trustworthiness sub-factor, said second artificial intelligence or machine learning trustworthiness related message is related to artificial intelligence or machine learning model adversarial robustness as said trustworthiness sub-factor, and said first artificial intelligence or machine learning trustworthiness related message comprises a first information element including at least one first artificial intelligence or machine learning model adversarial robustness related parameter.

### FIELD

Various example embodiments relate to trust related management of artificial intelligence or machine learning pipelines in relation to adversarial robustness. More specifically, various example embodiments exemplarily relate to measures (including methods, apparatuses and computer program products) for realizing trust related management of artificial intelligence or machine learning pipelines in relation to adversarial robustness.

### BACKGROUND

The present specification generally relates to safety and robustness of artificial intelligence (AI) or machine learning (ML) models in particular regarding adversarial attacks as an aspect of trustworthiness in relation to AI/ML models and the application thereof.

Adversarial attacks are studied using a variety of threat models. The two most common threat models are the whitebox and blackbox threat models.

In the whitebox threat model, an adversary has visibility into the model parameters including, but not limited to, the architecture, weights, pre- and post-processing steps. The whitebox threat model is thought to represent the strongest attacker as they have full knowledge of the system.

In the blackbox threat model, the adversary only has query access to the model. That is to say, given an input from the adversary, the model provides either a soft output (i.e., prediction probabilities) or a hard output (i.e., top-1 or top-k output labels). Blackbox attacks are perceived as the realistic threat model when evaluating a system for deployment.

There are four broad categories of adversarial attacks on AI/ML models.

FIG. 6 is a schematic diagram illustrating these four broad categories of adversarial attacks on AI/ML models.
1. Adversarial Evasion Attack: The Adversarial Evasion Attack is an inference time attack in which the adversary seeks to add adversarial noise to an input and create an adversarial sample. These samples, when provided to a well-trained target model, cause predictable errors at the model's output. Evasion attacks can be targeted (i.e., the noise causes a specific error at the output) or untargeted (i.e., the noise causes an error at the output, but the type of error is not important to the adversary). Evasion attacks can be classified into four types:
   (i) Gradient-based attack is a type of whitebox attack where the attacker uses the model's gradient with respect to the adversarial object in order to identify the optimal adversarial noise to add.
   (ii) Confidence score attack is a type of blackbox attack where the attacker uses the outputted classification confidence to estimate the gradients of the model, and then perform similar smart optimization to gradient-based attacks above.
   (iii) Hard label attack is a type of blackbox attack that rely solely on the label outputted by the model and does not require the confidence scores. This makes the attack more dumb but also more realistic.
   (iv) Surrogate model attack is very similar to gradient-based attacks, except that it requires an extra step. When the attacker does not have access to the model's internals but still wants to mount a whitebox attack, they can try to first rebuild the target's model, e.g., by repeatedly querying the target model and observing input-output pairs, and to then identify the optimal adversarial noise to add by performing a whitebox attack on the substitute model and transfer the learning to attack the target blackbox model.
2. Adversarial Poisoning Attack: The Adversarial Poisoning Attack is a training time attack in which the adversary uses direct or indirect methods to corrupt the training data in order to achieve a specific goal. Poisoning is a major concern whenever the adversary has the ability to influence the training data, such as in online learning, in which live data is periodically used to retrain the model so as to remain robust to concept drift. Through poisoning, an adversary can degrade model performance and inject backdoors into the model so as to induce certain errors when triggered. Poisoning is considered as an integrity attack because tampering with the training data impacts the model's ability to output correct predictions.
3. Adversarial Inference & Inversion Attacks: Adversarial Inference & Inversion Attacks are inference time attacks in which the adversary uses API access to a target blackbox model in order to extract information about the training data. In a model inference attack (e.g., confidence-based attack, label-based attack), the adversary uses the application programming interface (API) in order to learn the data distribution of the training data or determine if certain data points were used when training the target model. In an adversarial inversion attack, the adversary uses the API in an attempt to reconstruct a training data sample from its confidence score vector predicted by the target model. Adversarial inference is a major issue when the confidentiality of the data needs to be maintained due to privacy or proprietary reasons.
4. Adversarial Model Extraction (or Model Stealing) Attack: The Adversarial Model Extraction (or Model Stealing) Attack is an inference time attack in which the adversary uses API access to the target blackbox model in order to learn the target model's parameters or create an approximation of the target model. By querying the model and using the outputs as the labels along with their confidence scores, the adversary can train a new, substitute model whose performance is similar to the target model. Once trained, the adversary can re-use the model for its own purposes (theft) or perform evasion attacks on the substitute model, which can then be transferred to the target model with high likelihood to succeed. Adversarial model extraction is a major issue when the confidentiality of the model needs to be maintained e.g. due to intellectual property rights.

For each category of adversarial attacks outlined above, there are various defense mechanisms as introduced below.
1. Adversarial Evasion Defense: The Adversarial Evasion Defense addresses potential Adversarial Evasion Attacks. There are four popular types of evasion defenses:
   (i) Adversarial training is when the defender retrains the model with adversarial examples included in the training pool, but labelled with correct labels. This teaches the model to ignore the noise and only learn from “robust” features.
   (ii) Gradient masking is a way to hide the gradients of the model on the assumption that gradients are needed to compute powerful attacks on models. For example, defensive distillation is one popular method to mask gradients of the model.
   (iii) Input modification is when an input, before being passed to the model, is in some way “cleaned” to get rid of adversarial noise.
   (iv) Extra (NULL) class is an approach where, instead of forcing the model to guess the label when it clearly does not know what it is, it is given the option of abstaining. This is based on the assumption that models are trained on a very particular data distribution and by definition are clueless when taken outside the bounds of that.
2. Adversarial Poisoning Defense: The Adversarial Poisoning Defense addresses potential Adversarial Poisoning Attacks. A number of methods have been proposed to defend models against poisoning attacks such as detection of poisoned training data based on activations analysis, based on data provenance, or based on spectral signatures.
3. Adversarial Inference & Inversion Defenses: Adversarial Inference & Inversion Defenses address potential Adversarial Inference & Inversion Attacks. A number of studies make use of various regularization techniques and ensemble learning to reduce overfitting as a defense against inference attacks. When a model overfits on training data (i.e., members), the model behaves more confidently on their training data than others. As a result, the confidence scores of the model on members and non-members present different patterns, which enables the attacker to distinguish them. There are various defense methods to reduce overfitting: L2-Regularizer, Dropout, Min-Max game and Model Stacking. While most existing defenses focus on reducing overfitting to mitigate inference attacks, there are also approaches proposed from different angles such as MemGuard (turns the confidence score vector into an adversarial example to fool the attacker's membership classifier) and Differential Privacy (adds noise either to the objective function of the model or to the gradient of the model during minimizing the objective function).
4. Adversarial Model Extraction Defense: The Adversarial Model Extraction Defense addresses potential Adversarial Model Extraction (or Model Stealing) Attacks. The goal of the defender is to prevent the attacker from stealing private information or replicating the model's functionality. Specifically, given a certain budget of the attacker, the defender aims to reduce the accuracy of the stolen model established by the attacker. The defender tries to increase the cost of stealing the model to reach a certain accuracy target, thus the attacker is discouraged from performing the attack. There are two defense mechanisms: defending by output perturbation (i.e., injecting special perturbations to model predictions to obfuscate provided information such as prediction labels and confidence scores) and detecting by observing the queries (i.e., monitoring the queries from the clients and generating a warning if malicious behaviors are detected).

There are several measurable adversarial robustness metrics such as loss sensitivity, empirical robustness, and clever and pointwise differential training privacy.

In view thereof, a possibility for the network operator to influence AI/ML models and the application thereof in the context of adversarial robustness is necessary. However, no measures for implementing a control and evaluation of adversarial robustness as a trustworthiness aspect of AI/ML models are known.

Hence, the problem arises that control and evaluation of adversarial robustness as a trustworthiness aspect of AI/ML models in particular for interoperable and multi-vendor environments is to be provided.

Hence, there is a need to provide for trust related management of artificial intelligence or machine learning pipelines in relation to adversarial robustness.

### SUMMARY

Various example embodiments aim at addressing at least part of the above issues and/or problems and drawbacks.

Various aspects of example embodiments are set out in the appended claims.

According to an exemplary aspect, there is provided a method of a first network entity managing artificial intelligence or machine learning trustworthiness in a network, the method comprising transmitting a first artificial intelligence or machine learning trustworthiness related message towards a second network entity managing artificial intelligence or machine learning trustworthiness in an artificial intelligence or machine learning pipeline in said network, and receiving a second artificial intelligence or machine learning trustworthiness related message from said second network entity, wherein said first artificial intelligence or machine learning trustworthiness related message is related to artificial intelligence or machine learning model adversarial robustness as a trustworthiness sub-factor, said second artificial intelligence or machine learning trustworthiness related message is related to artificial intelligence or machine learning model adversarial robustness as said trustworthiness sub-factor, and said first artificial intelligence or machine learning trustworthiness related message comprises a first information element including at least one first artificial intelligence or machine learning model adversarial robustness related parameter.

According to an exemplary aspect, there is provided a method of a second network entity managing artificial intelligence or machine learning trustworthiness in an artificial intelligence or machine learning pipeline in a network, the method comprising receiving a first artificial intelligence or machine learning trustworthiness related message from a first network entity managing artificial intelligence or machine learning trustworthiness in said network, and transmitting a second artificial intelligence or machine learning trustworthiness related message towards said first network entity, wherein said first artificial intelligence or machine learning trustworthiness related message is related to artificial intelligence or machine learning model adversarial robustness as a trustworthiness sub-factor, said second artificial intelligence or machine learning trustworthiness related message is related to artificial intelligence or machine learning model adversarial robustness as said trustworthiness sub-factor, and said first artificial intelligence or machine learning trustworthiness related message comprises a first information element including at least one first artificial intelligence or machine learning model adversarial robustness related parameter.

According to an exemplary aspect, there is provided an apparatus of a first network entity managing artificial intelligence or machine learning trustworthiness in a network, the apparatus comprising transmitting circuitry configured to transmit a first artificial intelligence or machine learning trustworthiness related message towards a second network entity managing artificial intelligence or machine learning trustworthiness in an artificial intelligence or machine learning pipeline in said network, and receiving circuitry configured to receive a second artificial intelligence or machine learning trustworthiness related message from said second network entity, wherein said first artificial intelligence or machine learning trustworthiness related message is related to artificial intelligence or machine learning model adversarial robustness as a trustworthiness sub-factor, said second artificial intelligence or machine learning trustworthiness related message is related to artificial intelligence or machine learning model adversarial robustness as said trustworthiness sub-factor, and said first artificial intelligence or machine learning trustworthiness related message comprises a first information element including at least one first artificial intelligence or machine learning model adversarial robustness related parameter.

According to an exemplary aspect, there is provided an apparatus of a second network entity managing artificial intelligence or machine learning trustworthiness in an artificial intelligence or machine learning pipeline in a network, the apparatus comprising receiving circuitry configured to receive a first artificial intelligence or machine learning trustworthiness related message from a first network entity managing artificial intelligence or machine learning trustworthiness in said network, and transmitting circuitry configured to transmit a second artificial intelligence or machine learning trustworthiness related message towards said first network entity, wherein said first artificial intelligence or machine learning trustworthiness related message is related to artificial intelligence or machine learning model adversarial robustness as a trustworthiness sub-factor, said second artificial intelligence or machine learning trustworthiness related message is related to artificial intelligence or machine learning model adversarial robustness as said trustworthiness sub-factor, and said first artificial intelligence or machine learning trustworthiness related message comprises a first information element including at least one first artificial intelligence or machine learning model adversarial robustness related parameter.

According to an exemplary aspect, there is provided an apparatus of a first network entity managing artificial intelligence or machine learning trustworthiness in a network, the apparatus comprising at least one processor, at least one memory including computer program code, and at least one interface configured for communication with at least another apparatus, the at least one processor, with the at least one memory and the computer program code, being configured to cause the apparatus to perform transmitting a first artificial intelligence or machine learning trustworthiness related message towards a second network entity managing artificial intelligence or machine learning trustworthiness in an artificial intelligence or machine learning pipeline in said network, and receiving a second artificial intelligence or machine learning trustworthiness related message from said second network entity, wherein said first artificial intelligence or machine learning trustworthiness related message is related to artificial intelligence or machine learning model adversarial robustness as a trustworthiness sub-factor, said second artificial intelligence or machine learning trustworthiness related message is related to artificial intelligence or machine learning model adversarial robustness as said trustworthiness sub-factor, and said first artificial intelligence or machine learning trustworthiness related message comprises a first information element including at least one first artificial intelligence or machine learning model adversarial robustness related parameter.

According to an exemplary aspect, there is provided an apparatus of a second network entity managing artificial intelligence or machine learning trustworthiness in an artificial intelligence or machine learning pipeline in a network, the apparatus comprising at least one processor, at least one memory including computer program code, and at least one interface configured for communication with at least another apparatus, the at least one processor, with the at least one memory and the computer program code, being configured to cause the apparatus to perform receiving a first artificial intelligence or machine learning trustworthiness related message from a first network entity managing artificial intelligence or machine learning trustworthiness in said network, and transmitting a second artificial intelligence or machine learning trustworthiness related message towards said first network entity, wherein said first artificial intelligence or machine learning trustworthiness related message is related to artificial intelligence or machine learning model adversarial robustness as a trustworthiness sub-factor, said second artificial intelligence or machine learning trustworthiness related message is related to artificial intelligence or machine learning model adversarial robustness as said trustworthiness sub-factor, and said first artificial intelligence or machine learning trustworthiness related message comprises a first information element including at least one first artificial intelligence or machine learning model adversarial robustness related parameter.

According to an exemplary aspect, there is provided a computer program product comprising computer-executable computer program code which, when the program is run on a computer (e.g. a computer of an apparatus according to any one of the aforementioned apparatus-related exemplary aspects of the present disclosure), is configured to cause the computer to carry out the method according to any one of the aforementioned method-related exemplary aspects of the present disclosure.

Such computer program product may comprise (or be embodied) a (tangible) computer-readable (storage) medium or the like on which the computer-executable computer program code is stored, and/or the program may be directly loadable into an internal memory of the computer or a processor thereof.

Any one of the above aspects enables an efficient control and evaluation of AI/ML models in relation to adversarial robustness as a trustworthiness aspect to thereby solve at least part of the problems and drawbacks identified in relation to the prior art.

By way of example embodiments, there is provided trust related management of artificial intelligence or machine learning pipelines in relation to adversarial robustness. More specifically, by way of example embodiments, there are provided measures and mechanisms for realizing trust related management of artificial intelligence or machine learning pipelines in relation to adversarial robustness.

Thus, improvement is achieved by methods, apparatuses and computer program products enabling/realizing trust related management of artificial intelligence or machine learning pipelines in relation to adversarial robustness.

### BRIEF DESCRIPTION OF THE DRAWINGS

In the following, the present disclosure will be described in greater detail by way of non-limiting examples with reference to the accompanying drawings, in which

FIG. 1 is a block diagram illustrating an apparatus according to example embodiments,

FIG. 2 is a block diagram illustrating an apparatus according to example embodiments,

FIG. 3 is a block diagram illustrating an apparatus according to example embodiments,

FIG. 4 is a schematic diagram of a procedure according to example embodiments,

FIG. 5 is a schematic diagram of a procedure according to example embodiments,

FIG. 6 is a schematic diagram illustrating four broad categories of adversarial attacks on AI/ML models,

FIG. 7 shows a schematic diagram of an example of a system environment with interfaces and signaling variants according to example embodiments,

FIG. 8 shows a schematic diagram of signaling sequences according to example embodiments,

FIG. 9 shows a schematic diagram of signaling sequences according to example embodiments,

FIG. 10 shows a schematic diagram of signaling sequences according to example embodiments,

FIG. 11 shows a schematic diagram of beam selection processing according to example embodiments,

FIG. 12 shows a schematic diagram of beam selection processing according to example embodiments, and

FIG. 13 is a block diagram alternatively illustrating apparatuses according to example embodiments.

### DETAILED DESCRIPTION

The present disclosure is described herein with reference to particular non-limiting examples and to what are presently considered to be conceivable embodiments. A person skilled in the art will appreciate that the disclosure is by no means limited to these examples, and may be more broadly applied.

It is to be noted that the following description of the present disclosure and its embodiments mainly refers to specifications being used as non-limiting examples for certain exemplary network configurations and deployments. Namely, the present disclosure and its embodiments are mainly described in relation to 3GPP specifications being used as non-limiting examples for certain exemplary network configurations and deployments. As such, the description of example embodiments given herein specifically refers to terminology which is directly related thereto. Such terminology is only used in the context of the presented non-limiting examples, and does naturally not limit the disclosure in any way. Rather, any other communication or communication related system deployment, etc. may also be utilized as long as compliant with the features described herein.

Hereinafter, various embodiments and implementations of the present disclosure and its aspects or embodiments are described using several variants and/or alternatives. It is generally noted that, according to certain needs and constraints, all of the described variants and/or alternatives may be provided alone or in any conceivable combination (also including combinations of individual features of the various variants and/or alternatives).

According to example embodiments, in general terms, there are provided measures and mechanisms for (enabling/realizing) trust related management of artificial intelligence or machine learning pipelines in relation to adversarial robustness, and in particular measures and mechanisms for (enabling/realizing) management of adversarial robustness in trustworthy AI frameworks.

A framework for trustworthy artificial intelligence (TAI) in cognitive autonomous networks (CAN) underlies example embodiments.

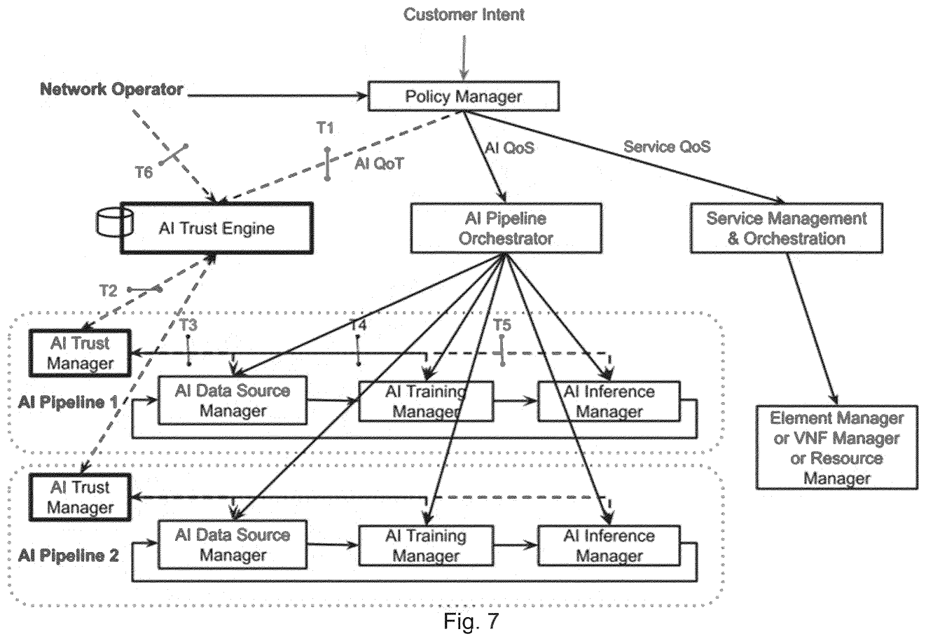

FIG. 7 shows a schematic diagram of an example of a system environment with interfaces and signaling variants according to example embodiments, and in particular illustrates example details of the trustworthy artificial intelligence framework (TAIF) in CANs underlying example embodiments.

Such TAIF for CANs may be provided to facilitate the definition, configuration, monitoring and measuring of AI/ML model trustworthiness (i.e., fairness, explainability, technical robustness, and adversarial robustness) for interoperable and multi-vendor environments. A service definition or the business/customer intent may include AI/ML trustworthiness requirements in addition to quality of service (Qos) requirements, and the TAIF is used to configure the requested AI/ML trustworthiness and to monitor and assure its fulfilment. The TAIF introduces two management functions, namely, a function entity named AI Trust Engine (one per management domain) and a function entity named AI Trust Manager (one per AI/ML pipeline). The TAIF further introduces six interfaces (named T1 to T6) that support interactions in the TAIF. According to the TAIF underlying example embodiments, the AI Trust Engine is center for managing AI trustworthiness related things in the network, whereas the AI Trust Managers are use case and often vendor specific, with knowledge of the AI use case and how it is implemented.

Furthermore, the TAIF underlying example embodiments introduces a concept of AI quality of trustworthiness (AI QoT) (as seen over the T1 interface in FIG. 7) to define AI/ML model trustworthiness in a unified way covering three factors, i.e., fairness, explainability, technical robustness and adversarial robustness, similar to how QoS is used for network performance.

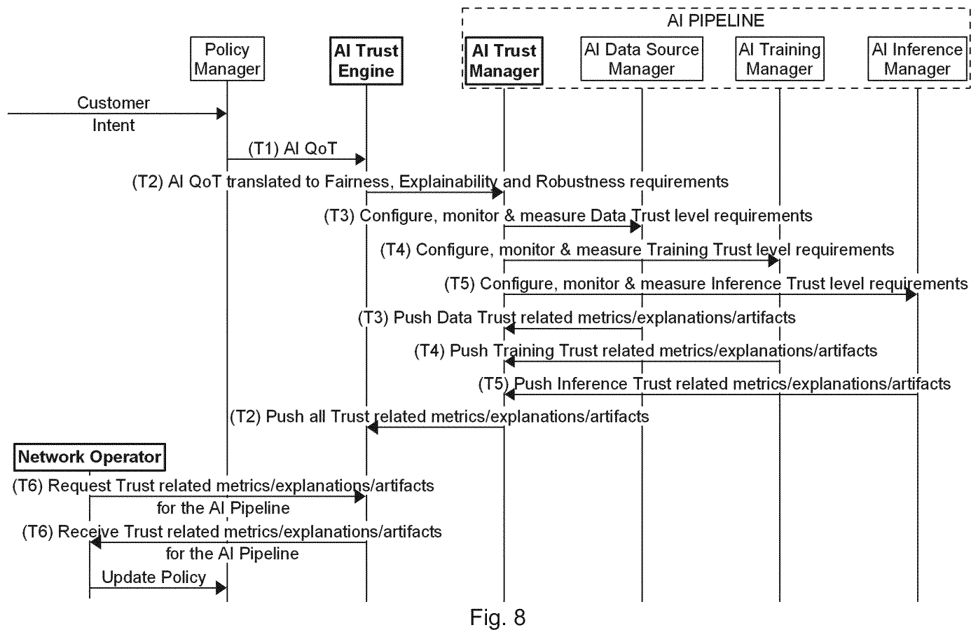

FIG. 8 shows a schematic diagram of signaling sequences according to example embodiments, and in particular illustrates an exemplary generic workflow in the TAIF underlying example embodiments.

Once the Policy Manager (entity) receives an intent from a customer, it is translated into AI QoT class identifier and sent to the AI Trust Engine (entity) over the T1 interface. The AI Trust Engine (entity) translates the AI QoT class identifier into AI trustworthiness (i.e., fairness, technical robustness, adversarial robustness, and explainability) requirements and sends it to the AI Trust Manager (entity) of the AI pipeline over the T2 interface. The AI Trust Manager (entity) may configure, monitor, and measure AI trustworthiness requirements (i.e., trust mechanisms and trust metrics) for an AI Data Source Manager (entity), an AI Training Manager (entity), and an AI Inference Manager (entity) (of a respective AI pipeline) over T3, T4 and

T5 interfaces, respectively. The measured or collected trustworthiness metrics/artifacts/explanations from the AI Data Source Manager (entity), the AI Training Manager (entity), and the AI Inference Manager (entity) regarding the AI pipeline may be pushed to the AI Trust Manager (entity) over T3, T4 and T5 interfaces, respectively. The AI Trust Manager (entity) may then push, over the T2 interface, all trustworthiness metrics/artifacts/explanations of the AI pipeline to the AI Trust Engine (entity), which may store the information in a trust knowledge database. Finally, the network operator can request and receive the trustworthiness metrics/explanations/artifacts of an AI pipeline from the AI Trust Engine (entity) over the T6 interface. Based on the information retrieved, the network operator may decide to update the policy via the Policy Manager (entity).

The TAIF underlying example embodiments allows the network operator to specify, over the T1 interface, the required AI QoT to the AI Trust Engine (entity) via the Policy Manager (entity). The AI Trust Engine (entity) translates the AI QoT into individual AI trustworthiness requirements (i.e., fairness, explainability, technical robustness, and adversarial robustness) and identifies the vendor-specific and use case-specific AI Trust Manager (entity) over the T2 interface. Although the identified vendor-specific AI Trust Manager (entity) knows “how” to configure, monitor and measure the AI adversarial robustness requirements for AI Data Source Manager (entity), AI Training Manager (entity), and AI Inference Manager (entity) over T3, T4 and T5 interfaces, respectively, the operator-controlled AI Trust Engine (entity) should be the one to determine “what” AI adversarial robustness methods are to be configured and/or AI adversarial robustness metrics are to be measured and/or AI adversarial robustness metric explanations are to be generated for a particular use case to achieve the desired AI QoT. Additionally, the AI Trust Engine (entity) should also be the one to determine “when” the collected AI adversarial robustness metrics and/or AI adversarial robustness metric explanations need to be reported back to the AI Trust Engine (entity) by the AI Trust Manager (entity). Therefore, considering that the AI Trust Manager (entity) is vendor-specific (a network may contain AI Trust Managers from several different vendors), according to example embodiments, APIs are provided to enable the operator to control adversarial robustness related aspects on the AI Trust Manager's side. In particular, potentially required operations and notifications utilizing the T2 interface to effect and/or facilitate and/or prepare configurations and reporting are specified and provided. More specifically, the AI Trust Engine (entity) needs the AI Trust Managers to provide an interface for the adversarial robustness functionality to be able to operate therewith. APIs according to example embodiments provided herein support AI adversarial robustness capability discovery, AI adversarial robustness configuration and AI adversarial robustness reporting between the AI Trust Engine (entity) and the AI Trust Manager (entity) for the T2 interface, and may accordingly be defined/standardized.

Hence, in brief, according to example embodiments, AI Trust Manager (entity) (which may be considered as a second network entity managing AI/ML trustworthiness in an AI/ML pipeline in a network) APIs for AI/ML adversarial robustness are provided that allow the AI Trust Engine (entity) (which may be considered as a first network entity managing AI/ML trustworthiness in a network), over the T2 interface, to discover AI adversarial robustness capabilities of the use case-specific AI pipeline, to configure proper AI adversarial robustness methods and/or AI adversarial robustness metrics to be measured and/or AI adversarial robustness metric explanations to be generated, and to query the AI adversarial robustness metrics report and/or AI adversarial robustness metric explanations report.

In particular, according to example embodiments, the following AI Trust Manager adversarial robustness-related APIs are provided.
1. TAI Adversarial Robustness Capability Discovery API (Request/Response)—It allows the AI Trust Engine (entity), via the T2 interface, to discover AI adversarial robustness methods and/or AI adversarial robustness metrics and/or AI adversarial robustness metric explanations that the AI Trust Manager (entity) is capable of configuring in the AI Data Source Manager (entity) and/or the AI Training Manager (entity) and/or the AI Inference Manager (entity).
2. TAI Adversarial Robustness Configuration API (Request/Response)—It allows the AI Trust Engine (entity), via the T2 interface, to configure appropriate AI adversarial robustness method(s) to be used, AI adversarial robustness metric(s) to be measured, and AI adversarial robustness metric explanation(s) to be generated in the AI Data Source Manager (entity) and/or the AI Training Manager (entity) and/or the AI Inference Manager (entity) via the AI Trust Manager (entity).
3. TAI Adversarial Robustness Reporting API (Request/Response and Subscribe/Notify)—It allows the AI Trust Engine (entity), via the T2 interface, to request/subscribe for AI adversarial robustness report (consisting of measured AI adversarial robustness metrics and generated AI adversarial robustness metric explanations) from the AI Trust Manager (entity).

Example embodiments are specified below in more detail.

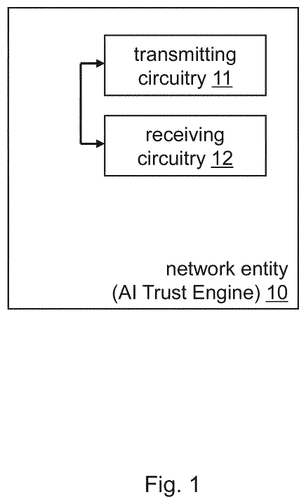

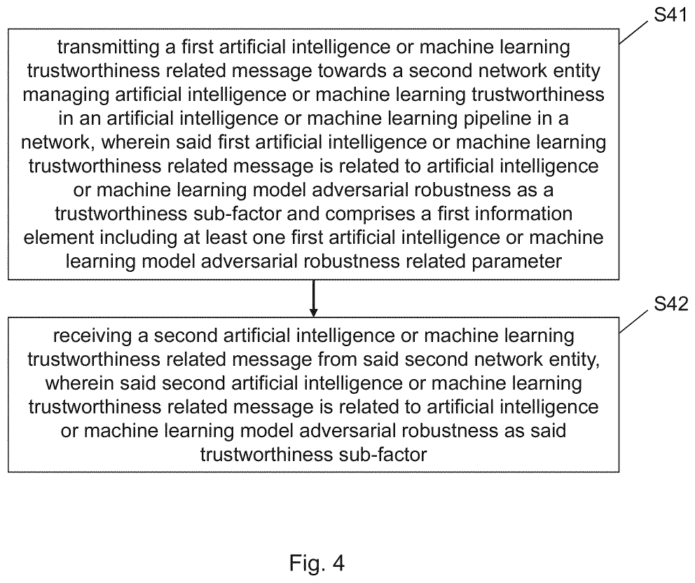

FIG. 1 is a block diagram illustrating an apparatus according to example embodiments. The apparatus may be a network node or entity 10 (first network entity) managing artificial intelligence or machine learning trustworthiness in a network such as an AI Trust Engine (entity) (or an entity providing or hosting such functionality) comprising a transmitting circuitry 11 and a receiving circuitry 12. The transmitting circuitry 11 transmits a first artificial intelligence or machine learning trustworthiness related message towards a second network entity managing artificial intelligence or machine learning trustworthiness in an artificial intelligence or machine learning pipeline in said network. The receiving circuitry 12 receives a second artificial intelligence or machine learning trustworthiness related message from said second network entity. Here, the first artificial intelligence or machine learning trustworthiness related message is related to artificial intelligence or machine learning model adversarial robustness as a trustworthiness sub-factor. Further, the second artificial intelligence or machine learning trustworthiness related message is related to artificial intelligence or machine learning model adversarial robustness as said trustworthiness sub-factor. Furthermore, the first artificial intelligence or machine learning trustworthiness related message comprises a first information element including at least one first artificial intelligence or machine learning model adversarial robustness related parameter. FIG. 4 is a schematic diagram of a procedure according to example embodiments. The apparatus according to FIG. 1 may perform the method of FIG. 4 but is not limited to this method. The method of FIG. 4 may be performed by the apparatus of FIG. 1 but is not limited to being performed by this apparatus.

As shown in FIG. 4, a procedure according to example embodiments comprises an operation of transmitting (S41) a first artificial intelligence or machine learning trustworthiness related message towards a second network entity managing artificial intelligence or machine learning trustworthiness in an artificial intelligence or machine learning pipeline in said network, and an operation of receiving (S42) a second artificial intelligence or machine learning trustworthiness related message from said second network entity. Here, the first artificial intelligence or machine learning trustworthiness related message is related to artificial intelligence or machine learning model adversarial robustness as a trustworthiness sub-factor. Further, the second artificial intelligence or machine learning trustworthiness related message is related to artificial intelligence or machine learning model adversarial robustness as said trustworthiness sub-factor. Furthermore, the first artificial intelligence or machine learning trustworthiness related message comprises a first information element including at least one first artificial intelligence or machine learning model adversarial robustness related parameter.

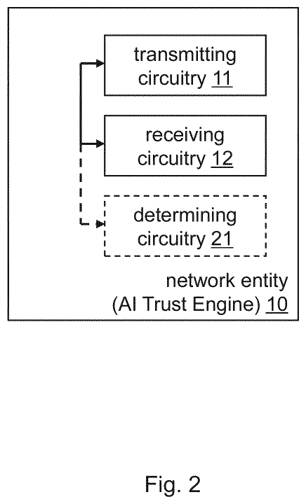

FIG. 2 is a block diagram illustrating an apparatus according to example embodiments. In particular, FIG. 2 illustrates a variation of the apparatus shown in FIG. 1. The apparatus according to FIG. 2 may thus further comprise a determining circuitry 21.

In an embodiment at least some of the functionalities of the apparatus shown in FIG. 1 (or 2) may be shared between two physically separate devices forming one operational entity. Therefore, the apparatus may be seen to depict the operational entity comprising one or more physically separate devices for executing at least some of the described processes.

According to further example embodiments, said first artificial intelligence or machine learning trustworthiness related message is a trustworthiness adversarial robustness capability information request, and said second artificial intelligence or machine learning trustworthiness related message is a trustworthiness adversarial robustness capability information response, and said second artificial intelligence or machine learning trustworthiness related message comprises a second information element including at least one second artificial intelligence or machine learning model adversarial robustness related parameter.

According to further example embodiments, said at least one first artificial intelligence or machine learning model adversarial robustness related parameter includes at least one of first scope information indicative of at least one artificial intelligence or machine learning pipeline to which said trustworthiness adversarial robustness capability information request relates, and first phase information indicative of at least one artificial intelligence or machine learning pipeline phase to which said trustworthiness adversarial robustness capability information request relates. Further, said at least one second artificial intelligence or machine learning model adversarial robustness related parameter includes at least one capability entry, wherein each respective capability entry of said at least one capability entry includes at least one of second scope information indicative of an artificial intelligence or machine learning pipeline to which said respective capability entry relates, second phase information indicative of at least one artificial intelligence or machine learning pipeline phase to which said respective capability entry relates, adversarial defense method information indicative of at least one adversarial defense method category including at least one category adversarial defense method, and of, for each respective category adversarial defense method, whether said respective category adversarial defense method is supported for said at least one artificial intelligence or machine learning pipeline phase of said artificial intelligence or machine learning pipeline to which said respective capability entry relates, adversarial robustness metrics information indicative of at least one adversarial robustness metric, and of, for each respective adversarial robustness metric, whether said respective adversarial robustness metric is supported for said at least one artificial intelligence or machine learning pipeline phase of said artificial intelligence or machine learning pipeline to which said respective capability entry relates, and adversarial robustness metric explanations information indicative of at least one adversarial robustness metric explanation, and of, for each respective adversarial robustness metric explanation, whether said respective adversarial robustness metric explanation is supported for said at least one artificial intelligence or machine learning pipeline phase of said artificial intelligence or machine learning pipeline to which said respective capability entry relates.

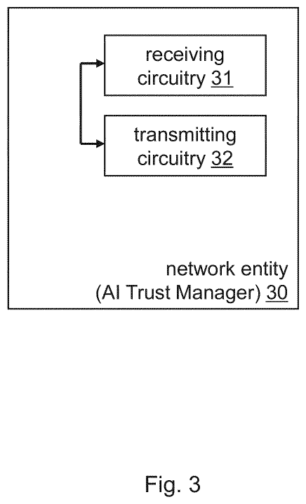

According to a variation of the procedure shown in FIG. 3, exemplary additional operations are given, which are inherently independent from each other as such. According to such variation, an exemplary method according to example embodiments may comprise an operation of determining, based on acquired capability information with respect to artificial intelligence or machine learning model adversarial robustness as said trustworthiness sub-factor, whether requirements related to artificial intelligence or machine learning model adversarial robustness as said trustworthiness sub-factor can be satisfied. Here, said first artificial intelligence or machine learning trustworthiness related message is a trustworthiness adversarial robustness configuration request. Further, said second artificial intelligence or machine learning trustworthiness related message is a trustworthiness adversarial robustness configuration response.

According to further example embodiments, said at least one first artificial intelligence or machine learning model adversarial robustness related parameter includes at least one configuration entry, wherein each respective configuration entry of said at least one configuration entry includes at least one of scope information indicative of an artificial intelligence or machine learning pipeline to which said respective configuration entry relates, phase information indicative of at least one artificial intelligence or machine learning pipeline phase to which said respective configuration entry relates, adversarial defense method information indicative of at least one adversarial defense method category including at least one category adversarial defense method, and of, for each respective category adversarial defense method, whether said respective category adversarial defense method is demanded for said at least one artificial intelligence or machine learning pipeline phase of said artificial intelligence or machine learning pipeline to which said respective configuration entry relates, adversarial robustness metrics information indicative of at least one adversarial robustness metric, and of, for each respective adversarial robustness metric, whether said respective adversarial robustness metric is demanded for said at least one artificial intelligence or machine learning pipeline phase of said artificial intelligence or machine learning pipeline to which said respective configuration entry relates, and adversarial robustness metric explanations information indicative of at least one adversarial robustness metric explanation, and of, for each respective adversarial robustness metric explanation, whether said respective adversarial robustness metric explanation is demanded for said at least one artificial intelligence or machine learning pipeline phase of said artificial intelligence or machine learning pipeline to which said respective configuration entry relates.

According to further example embodiments, said first artificial intelligence or machine learning trustworthiness related message is a trustworthiness adversarial robustness report request, and said second artificial intelligence or machine learning trustworthiness related message is a trustworthiness adversarial robustness report response, and said second artificial intelligence or machine learning trustworthiness related message comprises a second information element including at least one second artificial intelligence or machine learning model adversarial robustness related parameter.

According to further example embodiments, said at least one first artificial intelligence or machine learning model adversarial robustness related parameter includes at least one of scope information indicative of an artificial intelligence or machine learning pipeline to which said trustworthiness adversarial robustness report request relates, phase information indicative of at least one artificial intelligence or machine learning pipeline phase to which said trustworthiness adversarial robustness report request relates, a list indicative of adversarial robustness metrics demanded to be reported, a list indicative of adversarial robustness metric explanations demanded to be reported, start time information indicative of a begin of a timeframe for which reporting is demanded with said trustworthiness adversarial robustness report request, stop time information indicative of an end of said timeframe for which reporting is demanded with said trustworthiness adversarial robustness report request, and periodicity information indicative of a periodicity interval with which reporting is demanded with said trustworthiness adversarial robustness report request. Further, said at least one second artificial intelligence or machine learning model adversarial robustness related parameter includes at least one of demanded adversarial robustness metrics, and demanded adversarial robustness metric explanations.

According to further example embodiments, said first artificial intelligence or machine learning trustworthiness related message is a trustworthiness adversarial robustness subscription, and said second artificial intelligence or machine learning trustworthiness related message is a trustworthiness adversarial robustness notification, and said second artificial intelligence or machine learning trustworthiness related message comprises a second information element including at least one second artificial intelligence or machine learning model adversarial robustness related parameter.

According to further example embodiments, said at least one first artificial intelligence or machine learning model adversarial robustness related parameter includes at least one of scope information indicative of an artificial intelligence or machine learning pipeline to which said trustworthiness adversarial robustness subscription relates, phase information indicative of at least one artificial intelligence or machine learning pipeline phase to which said trustworthiness adversarial robustness subscription relates, a list indicative of adversarial robustness metrics demanded to be reported, at least one reporting threshold corresponding to at least one of said adversarial robustness metrics demanded to be reported, and adversarial attack alarm subscription information. Further, said at least one second artificial intelligence or machine learning model adversarial robustness related parameter includes demanded adversarial robustness metrics.

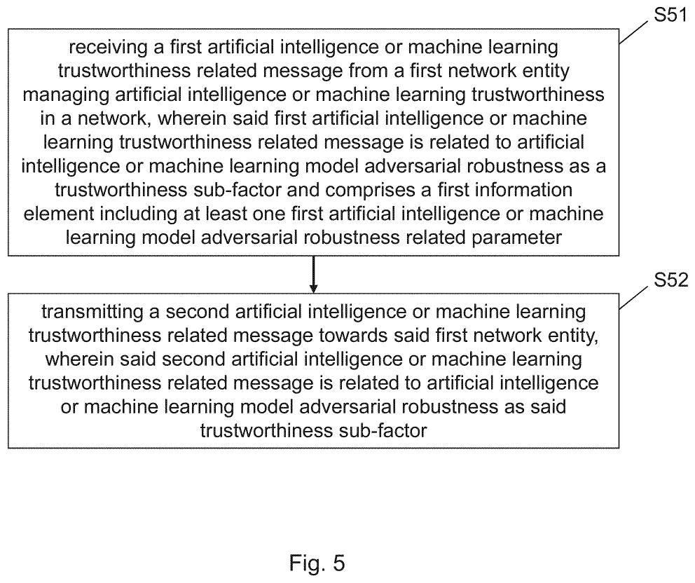

FIG. 3 is a block diagram illustrating an apparatus according to example embodiments. The apparatus may be a network node or entity 30 (second network entity) managing artificial intelligence or machine learning trustworthiness in an artificial intelligence or machine learning pipeline in a network such as an AI Trust Manager (entity) (or an entity providing or hosting such functionality) comprising a receiving circuitry 31 and a transmitting circuitry 32. The receiving circuitry 31 receives a first artificial intelligence or machine learning trustworthiness related message from a first network entity managing artificial intelligence or machine learning trustworthiness in said network. The transmitting circuitry 32 transmits a second artificial intelligence or machine learning trustworthiness related message towards said first network entity. Here, the first artificial intelligence or machine learning trustworthiness related message is related to artificial intelligence or machine learning model adversarial robustness as a trustworthiness sub-factor. Further, the second artificial intelligence or machine learning trustworthiness related message is related to artificial intelligence or machine learning model adversarial robustness as said trustworthiness sub-factor. Still further, the first artificial intelligence or machine learning trustworthiness related message comprises a first information element including at least one first artificial intelligence or machine learning model adversarial robustness related parameter. FIG. 5 is a schematic diagram of a procedure according to example embodiments. The apparatus according to FIG. 3 may perform the method of FIG. 5 but is not limited to this method. The method of FIG. 5 may be performed by the apparatus of FIG. 3 but is not limited to being performed by this apparatus.

As shown in FIG. 5, a procedure according to example embodiments comprises an operation of receiving (S51) a first artificial intelligence or machine learning trustworthiness related message from a first network entity managing artificial intelligence or machine learning trustworthiness in said network, and an operation of transmitting (S52) a second artificial intelligence or machine learning trustworthiness related message towards said first network entity. Here, the first artificial intelligence or machine learning trustworthiness related message is related to artificial intelligence or machine learning model adversarial robustness as a trustworthiness sub-factor. Further, the second artificial intelligence or machine learning trustworthiness related message is related to artificial intelligence or machine learning model adversarial robustness as said trustworthiness sub-factor. Still further, the first artificial intelligence or machine learning trustworthiness related message comprises a first information element including at least one first artificial intelligence or machine learning model adversarial robustness related parameter.

In an embodiment at least some of the functionalities of the apparatus shown in FIG. 3 may be shared between two physically separate devices forming one operational entity. Therefore, the apparatus may be seen to depict the operational entity comprising one or more physically separate devices for executing at least some of the described processes.

According to further example embodiments, said first artificial intelligence or machine learning trustworthiness related message is a trustworthiness adversarial robustness capability information request, and said second artificial intelligence or machine learning trustworthiness related message is a trustworthiness adversarial robustness capability information response, and said second artificial intelligence or machine learning trustworthiness related message comprises a second information element including at least one second artificial intelligence or machine learning model adversarial robustness related parameter.

According to further example embodiments, said at least one first artificial intelligence or machine learning model adversarial robustness related parameter includes at least one of first scope information indicative of at least one artificial intelligence or machine learning pipeline to which said trustworthiness adversarial robustness capability information request relates, and first phase information indicative of at least one artificial intelligence or machine learning pipeline phase to which said trustworthiness adversarial robustness capability information request relates. Further, said at least one second artificial intelligence or machine learning model adversarial robustness related parameter includes at least one capability entry, wherein each respective capability entry of said at least one capability entry includes at least one of second scope information indicative of an artificial intelligence or machine learning pipeline to which said respective capability entry relates, second phase information indicative of at least one artificial intelligence or machine learning pipeline phase to which said respective capability entry relates, adversarial defense method information indicative of at least one adversarial defense method category including at least one category adversarial defense method, and of, for each respective category adversarial defense method, whether said respective category adversarial defense method is supported for said at least one artificial intelligence or machine learning pipeline phase of said artificial intelligence or machine learning pipeline to which said respective capability entry relates, adversarial robustness metrics information indicative of at least one adversarial robustness metric, and of, for each respective adversarial robustness metric, whether said respective adversarial robustness metric is supported for said at least one artificial intelligence or machine learning pipeline phase of said artificial intelligence or machine learning pipeline to which said respective capability entry relates, and adversarial robustness metric explanations information indicative of at least one adversarial robustness metric explanation, and of, for each respective adversarial robustness metric explanation, whether said respective adversarial robustness metric explanation is supported for said at least one artificial intelligence or machine learning pipeline phase of said artificial intelligence or machine learning pipeline to which said respective capability entry relates.

According to further example embodiments, said first artificial intelligence or machine learning trustworthiness related message is a trustworthiness adversarial robustness configuration request, and said second artificial intelligence or machine learning trustworthiness related message is a trustworthiness adversarial robustness configuration response.

According to further example embodiments, said at least one first artificial intelligence or machine learning model adversarial robustness related parameter includes at least one configuration entry, wherein each respective configuration entry of said at least one configuration entry includes at least one of scope information indicative of an artificial intelligence or machine learning pipeline to which said respective configuration entry relates, phase information indicative of at least one artificial intelligence or machine learning pipeline phase to which said respective configuration entry relates, adversarial defense method information indicative of at least one adversarial defense method category including at least one category adversarial defense method, and of, for each respective category adversarial defense method, whether said respective category adversarial defense method is demanded for said at least one artificial intelligence or machine learning pipeline phase of said artificial intelligence or machine learning pipeline to which said respective configuration entry relates, adversarial robustness metrics information indicative of at least one adversarial robustness metric, and of, for each respective adversarial robustness metric, whether said respective adversarial robustness metric is demanded for said at least one artificial intelligence or machine learning pipeline phase of said artificial intelligence or machine learning pipeline to which said respective configuration entry relates, and adversarial robustness metric explanations information indicative of at least one adversarial robustness metric explanation, and of, for each respective adversarial robustness metric explanation, whether said respective adversarial robustness metric explanation is demanded for said at least one artificial intelligence or machine learning pipeline phase of said artificial intelligence or machine learning pipeline to which said respective configuration entry relates.

According to further example embodiments, said first artificial intelligence or machine learning trustworthiness related message is a trustworthiness adversarial robustness report request, and said second artificial intelligence or machine learning trustworthiness related message is a trustworthiness adversarial robustness report response, and said second artificial intelligence or machine learning trustworthiness related message comprises a second information element including at least one second artificial intelligence or machine learning model adversarial robustness related parameter.

According to further example embodiments, said at least one first artificial intelligence or machine learning model adversarial robustness related parameter includes at least one of scope information indicative of an artificial intelligence or machine learning pipeline to which said trustworthiness adversarial robustness report request relates, phase information indicative of at least one artificial intelligence or machine learning pipeline phase to which said trustworthiness adversarial robustness report request relates, a list indicative of adversarial robustness metrics demanded to be reported, a list indicative of adversarial robustness metric explanations demanded to be reported, start time information indicative of a begin of a timeframe for which reporting is demanded with said trustworthiness adversarial robustness report request, stop time information indicative of an end of said timeframe for which reporting is demanded with said trustworthiness adversarial robustness report request, and periodicity information indicative of a periodicity interval with which reporting is demanded with said trustworthiness adversarial robustness report request. Further, said at least one second artificial intelligence or machine learning model adversarial robustness related parameter includes at least one of demanded adversarial robustness metrics, and demanded adversarial robustness metric explanations.

According to further example embodiments, said first artificial intelligence or machine learning trustworthiness related message is a trustworthiness adversarial robustness subscription, and said second artificial intelligence or machine learning trustworthiness related message is a trustworthiness adversarial robustness notification, and said second artificial intelligence or machine learning trustworthiness related message comprises a second information element including at least one second artificial intelligence or machine learning model adversarial robustness related parameter.

According to further example embodiments, said at least one first artificial intelligence or machine learning model adversarial robustness related parameter includes at least one of scope information indicative of an artificial intelligence or machine learning pipeline to which said trustworthiness adversarial robustness subscription relates, phase information indicative of at least one artificial intelligence or machine learning pipeline phase to which said trustworthiness adversarial robustness subscription relates, a list indicative of adversarial robustness metrics demanded to be reported, at least one reporting threshold corresponding to at least one of said adversarial robustness metrics demanded to be reported, and adversarial attack alarm subscription information. Further, said at least one second artificial intelligence or machine learning model adversarial robustness related parameter includes demanded adversarial robustness metrics.

Example embodiments outlined and specified above are explained below in more specific terms.

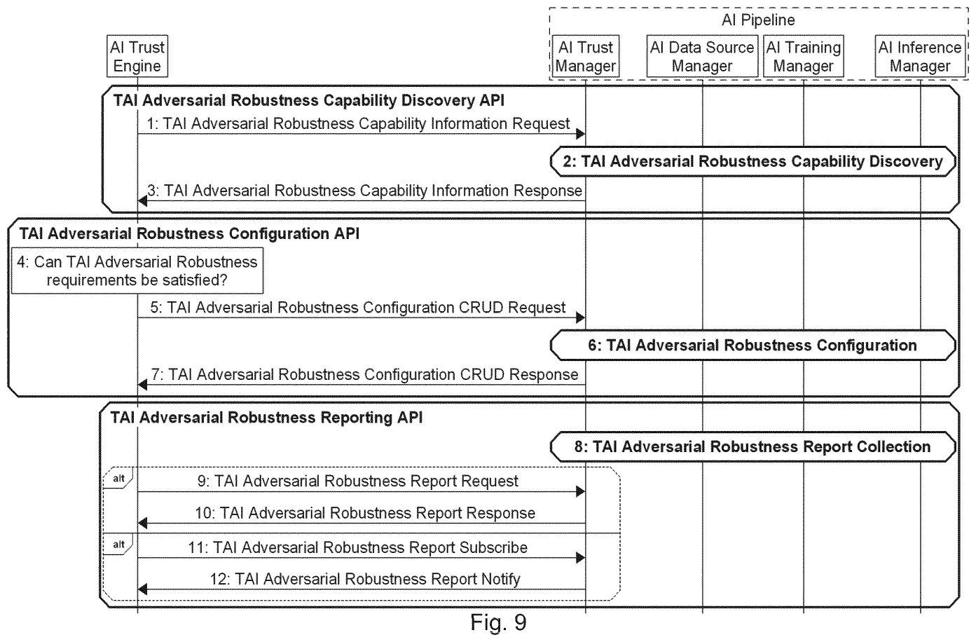

FIG. 9 shows a schematic diagram of signaling sequences according to example embodiments, and in particular illustrates AI adversarial robustness APIs offered by the AI Trust Manager (entity) to the AI Trust Engine (entity) over the T2 interface according to example embodiments.

More specifically, FIG. 9 shows the sequence diagram illustrating on how the AI Trust Engine (entity) can use the TAI adversarial robustness APIs offered by the AI Trust Manager (entity) over the T2 interface to discover and/or configure and/or report AI technical robustness and adversarial robustness methods and/or AI technical robustness and adversarial robustness metrics and/or AI technical robustness and adversarial robustness metric explanations from the use case-specific AI pipelines.

It is noted that the order of processing is not limited to that illustrated. As an example, steps of the reporting processing might be performed before steps of the configuration processing.

Steps 1 to 3 of FIG. 9 represent the TAI Adversarial Robustness Capability Discovery API according to example embodiments and corresponding capability processing.

In a step 1 of FIG. 9, according to example embodiments, a TAI Adversarial Robustness Capability Information Request (TAIARCIReq) is sent from the AI Trust Engine (entity) to the use case-specific AI Trust Manager (entity), requesting information concerning AI adversarial robustness methods (may be based on modifying training/inference data and/or based on modifying model parameters and/or based on adding auxiliary model) and/or AI adversarial robustness metrics and/or AI adversarial robustness metric explanations that the AI Trust Manager (entity) is capable of configuring in the AI Data Source Manager (entity) and/or AI Training Manager (entity) and/or AI Inference Manager (entity). According to example embodiments, the TAIARCIReq may comprise one or more of the parameters specified in the table below.

| | Mandatory/ | |
|---|---|---|
| Parameter | Optional | Description |
| CNF Scope | Mandatory | Which AI pipelines the AI adversarial |
| | | robustness capability information is |
| | | requested for. |
| >CNF Phase | Optional | Which phase (data, training, inference) |
| | | of the AI pipeline the AI adversarial |
| | | robustness capability information is |
| | | requested for. The default is for all stages. |

In a step 2 of FIG. 9, the AI Trust Manager (entity) determines all the information requested in the TAIARCIReq by interacting with the AI Data Source Manager (entity) and/or the AI Training Manager (entity) and/or the AI Inference Manager (entity) of the use case.

In a step 3 of FIG. 9, according to example embodiments, the AI Trust Manager (entity) sends a TAI Adversarial Robustness Capability Information Response (TAIARCIResp) consisting of all the information about the use case on the supported AI adversarial robustness methods and/or AI adversarial robustness metrics and/or AI adversarial robustness metric explanations back to the AI Trust Engine (entity). According to example embodiments, the TAIARCIResp may comprise one or more of the parameters specified in the table below.

| | Mandatory/ | |
|---|---|---|
| Parameter | Optional | Description |
| CNF ID | Mandatory | Which AI pipeline the AI adversarial |
| | | robustness capability information is |
| | | valid for. |
| >CNF Phase | Optional | Which phase (data, training, |
| | | inference) of the AI pipeline the AI |
| | | adversarial robustness capability |
| | | information is valid for. |
| >>Supported AI | Mandatory | Which AI adversarial evasion |
| Adversarial Evasion | | defense methods are supported in |
| Defense Methods | | a particular phase of the AI |
| | | pipeline. |
| >>Supported AI | Mandatory | Which AI adversarial poisoning |
| Adversarial | | defense methods are supported in |
| Poisoning | | a particular phase of the AI |
| Defense Methods | | pipeline. |
| >>Supported AI | Mandatory | Which AI adversarial inference & |
| Adversarial | | inversion defense methods are |
| Inference & | | supported in a particular phase of |
| Inversion Defense | | the AI pipeline. |
| Methods | | |
| >>Supported AI | Mandatory | Which AI adversarial model |
| Adversarial Model | | extraction defense methods are |
| Extraction Defense | | supported in a particular phase of |
| Methods | | the AI pipeline. |
| >>Supported AI | Mandatory | Which AI adversarial robustness |
| Adversarial | | metrics are supported in a |
| Robustness Metrics | | particular phase of the AI pipeline. |
| >>Supported AI | Mandatory | Which AI adversarial robustness |
| Adversarial | | metric explanations are supported |
| Robustness Metric | | in a particular phase of the AI |
| Explanations | | pipeline. |
| Additional | Optional | Free text description of the AI |
| Information | | adversarial robustness capabilities |
| | | in the AI pipeline. |

Steps 4 to 7 of FIG. 9 represent the TAI Adversarial Robustness Configuration API according to example embodiments and corresponding configuration processing.

In a step 4 of FIG. 9, according to example embodiments, the AI Trust Engine (entity) evaluates the AI adversarial robustness capability information provided by the AI Trust Manager (entity) in the TAIAICIResp with the desired AI QoT adversarial robustness requirements for the use case.

In a step 5 of FIG. 9, according to example embodiments, a TAI Adversarial Robustness Configuration CRUD Request (TAIARConReq) is sent from the AI Trust Engine (entity) to the use case-specific AI Trust Manager (entity) for configuring (creating, reading, updating and deleting (CRUD)) appropriate AI adversarial robustness method(s), AI adversarial robustness metric(s) to be measured, and AI adversarial robustness metric explanation(s) to be generated. The type of adversarial robustness methods to be configured can be determined based on attack vectors identified during a risk and threat analysis of the AI pipeline. According to example embodiments, the TAIARConReq may comprise one or more of the parameters specified in the table below.

| | Mandatory/ | |
|---|---|---|
| Parameter | Optional | Description |
| CNF ID | Mandatory | Which AI pipeline the AI adversarial |
| | | robustness configuration is requested |
| | | for. |
| >CNF Phase | Optional | Which phase (data, training, inference) |
| | | of the AI pipeline the AI adversarial |
| | | robustness configuration is requested |
| | | for. |
| >>AI Adversarial | Optional | Which AI adversarial evasion defense |
| Evasion Defense | | method needs to be configured in a |
| Method | | particular phase of the AI pipeline. |
| >>AI Adversarial | Optional | Which AI adversarial poisoning defense |
| Poisoning | | method needs to be configured in a |
| Defense Method | | particular phase of the AI pipeline. |
| >>AI Adversarial | Optional | Which AI adversarial inference & |
| Inference & | | inversion defense method needs to be |
| Inversion Defense | | configured in a particular phase of the |
| Method | | AI pipeline. |
| >>AI Adversarial | Optional | Which AI adversarial model extraction |
| Model Extraction | | defense method needs to be configured |
| Method | | in a particular phase of the AI pipeline. |
| >>AI Adversarial | Optional | Which AI adversarial robustness |
| Robustness | | metrics need to be configured in a |
| Metrics | | particular phase of the AI pipeline. |
| >>AI Adversarial | Optional | Which AI adversarial robustness metric |
| Robustness | | explanations need to be configured in a |
| Metric | | particular phase of the AI pipeline. |
| Explanations | | |

In a step 6 of FIG. 9, the AI Trust Manager (entity) configures the requested adversarial robustness methods/metrics/metric explanations in the AI Data Source Manager (entity) and/or the AI Training Manager (entity) and/or the AI Inference Manager (entity) of the use case.

In a step 7 of FIG. 9, according to example embodiments, depending on whether the configuration process in the previous step was successful or not, the AI Trust Manager (entity) responds to the AI Trust Engine (entity) with a TAI Adversarial Robustness Configuration CRUD Response (TAIARConResp) containing an acknowledgement (ACK)/non-acknowledgement (NACK).

Steps 8 to 12 of FIG. 9 represent the TAI Adversarial Robustness Reporting API according to example embodiments and corresponding reporting processing.

In a step 8 of FIG. 9, the AI Trust Manager (entity) collects the TAI adversarial robustness reports (metrics and/or metric explanations) as configured in step 5 of Figure from the AI Data Source Manager (entity) and/or the AI Training Manager (entity) and/or the AI Inference Manager (entity) of the use case.

In a step 9 of FIG. 9, according to example embodiments, a TAI Adversarial Robustness Report Request (TAIARRReq) containing the reporting configuration is sent from the AI Trust Engine (entity) to the use case-specific AI Trust Manager (entity). According to example embodiments, the TAIARRReq may comprise one or more of the parameters specified in the table below.

| | Mandatory/ | |
|---|---|---|
| Parameter | Optional | Description |
| CNF ID | Mandatory | Which AI pipeline the AI adversarial |
| | | robustness report is requested for. |
| >CNF Phase | Optional | Which phase (data, training, inference) |
| | | of the AI pipeline the AI adversarial |
| | | robustness report is requested for. |
| >>List of AI | Mandatory | Which AI adversarial robustness |
| Adversarial | | metrics need to be reported. |
| Robustness | | |
| metrics | | |
| >>List of AI | Mandatory | Which AI adversarial robustness metric |
| Adversarial | | explanations need to be reported. |
| Robustness metric | | |
| explanations | | |
| >>Start Time | Optional | If Report Type is periodic, what is the |
| | | start time for reporting. |
| >>End Time | Optional | If Report Type is periodic, what is the |
| | | end time for reporting. |
| >>Report Interval | Optional | If Report Type is periodic, what is the |
| | | periodicity interval for reporting the AI |
| | | adversarial robustness metrics and/or |
| | | metric explanations. |

For explanation of step 10 of FIG. 9 it is supposed that one or more reporting characteristics (i.e., periodic or on-demand) is met. In that case, in step 10 of FIG. 9, according to example embodiments, the AI Trust Manager (entity) sends a TAI Adversarial Robustness Report Response (TAIARRResp) to the AI Trust Engine (entity) as per the reporting configuration specified in the TAIARRReq.

Alternatively to step 9 of FIG. 9, where the AI Trust Engine (entity) requests the AI Trust Manager (entity) for single/periodic reports (i.e., Request-Response model), in a step 11 of FIG. 9, according to example embodiments, the AI Trust Engine (entity) may subscribe to notifications/reports from the AI Trust Manager (entity) (i.e., Subscribe-Notify model) via a TAI Adversarial Robustness Report Subscribe (TAIARRSub) message. According to example embodiments, the TAIARRSub may comprise one or more of the parameters specified in the table below.

| | Mandatory/ | |
|---|---|---|
| Parameter | Optional | Description |
| CNF ID | Mandatory | Which AI pipeline the AI adversarial |
| | | robustness report is requested for. |
| >CNF Phase | Optional | Which phase (data, training, inference) |
| | | of the AI pipeline the AI adversarial |
| | | robustness report is requested for. |
| >>Applicable | Mandatory | Which AI adversarial robustness metrics |
| AI Adversarial | | need to be reported. |
| Robustness | | |
| metrics | | |
| >>Crossed | Mandatory | If a particular adversarial robustness |
| Reporting | | metric exceeded the reporting |
| Threshold(s) | | threshold, then report the AI adversarial |
| | | robustness metrics and corresponding |
| | | metric explanations. |
| >>Adversarial | Optional | A filter defining the reporting criteria for |
| attack alarm | | adversarial attack alarms raised by the |
| subscription | | AI Trust Manager. |
| filter | | |

For explanation of step 12 of FIG. 9 it is supposed that one or more reporting thresholds are met for the applicable AI adversarial robustness metrics or the AI Trust Manager (entity) detects a possible adversarial attack and raises an alarm. In that case, in step 12 of FIG. 9, according to example embodiments, the AI Trust Manager (entity) sends a TAI Adversarial Robustness Report Notify (TAIARRNot) message to the AI Trust Engine (entity) consisting of actual AI adversarial robustness reports and/or an adversarial attack alarm ID, which identifies the potential attack that has been detected.

A specific example is given below for the particular use case “TAI Adversarial Robustness in ML-based mmWave Beam Prediction” to illustrate the usage of TAI adversarial robustness APIs provided for the T2 interface according to example embodiments.

mmWave Beam Management is a procedure for determining which beams must be allocated to which UEs (either in Idle mode or Connected mode) at a given time slot.

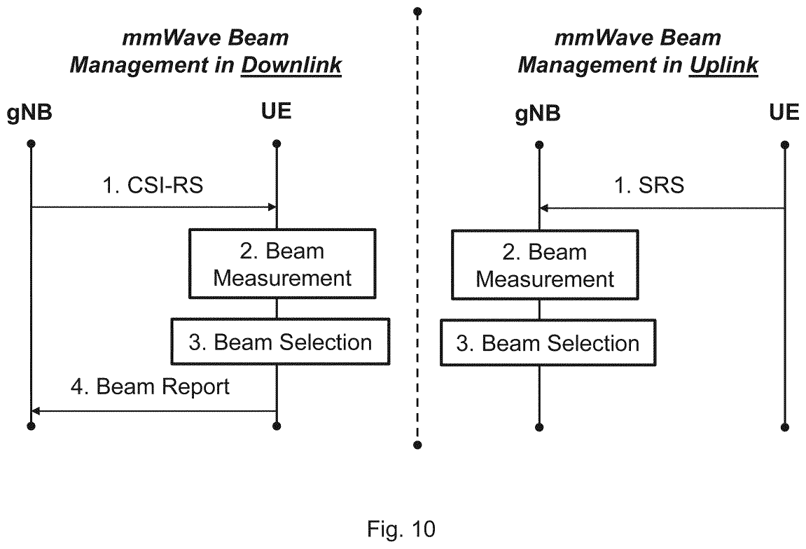

FIG. 10 shows a schematic diagram of signaling sequences according to example embodiments, and in particular illustrates TAI-based mmWave Beam Management.

The beam management procedure in general consist of four main steps, as indicated in FIG. 10. Here, the left part of FIG. 10 illustrates the downlink (DL) case, while the right part of FIG. 10 illustrates the uplink (UL) case.

In a step 1 of FIG. 10, Beam Sweeping is performed. A spatial area is covered by a set of beams which are transmitted and received in a burst at regular defined intervals. In downlink, a gNB transmits a pool (one per beam) of Channel State Information Reference Signals (CSI-RS), while in uplink, a user equipment (UE) transmits a pool (one per beam) of Sounding Reference Signals (SRS).

In a step 2 of FIG. 10, Beam Measurement is performed. The gNB or the UE measures the signal quality (i.e., received signal power) of all the reference signals based on some metric.

In a step 3 of FIG. 10, Beam Selection is performed. The gNB or the UE selects the most suitable beam based on the beam measurements.

In a step 4 of FIG. 10, Beam Reporting (only in downlink) is performed. The UE sends the report containing the information about beam measurements (e.g., Reference Signal Received Power (RSRP)) and beam selection (e.g., beam ID). Finally, the gNB may also decide to allocate a different beam to the UE than the one selected by the UE in step 3 of FIG. 10.

The exhaustive beam selection procedure (as described above with reference to FIG. 10) is very time consuming and inefficient. Therefore, ML-based mmWave Beam Prediction may be applied.

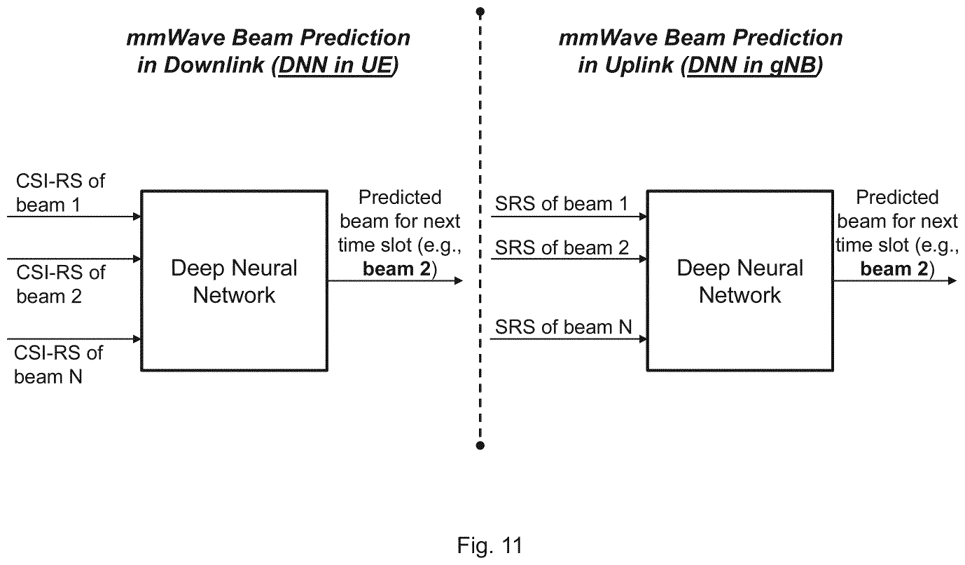

FIG. 11 shows a schematic diagram of beam selection processing according to example embodiments, and in particular illustrates ML-based mmWave Beam Prediction based on Deep Neural Networks.

Namely, deep learning-based beam selection techniques have been proposed to optimize the beam selection process, where a deep neural network (located in UE for downlink and in gNB for uplink) takes as input the reference signals (CSI-RS for DL and SRS for UL) from all the beams and provides/predicts as output the most suitable beam for the next time slot (e.g., beam 2 as illustrated in FIG. 11).

Although the deep neural network improves the latency and reliability of beam selection compared to the conventional approach, the deep neural network itself may be prone to adversarial attacks.

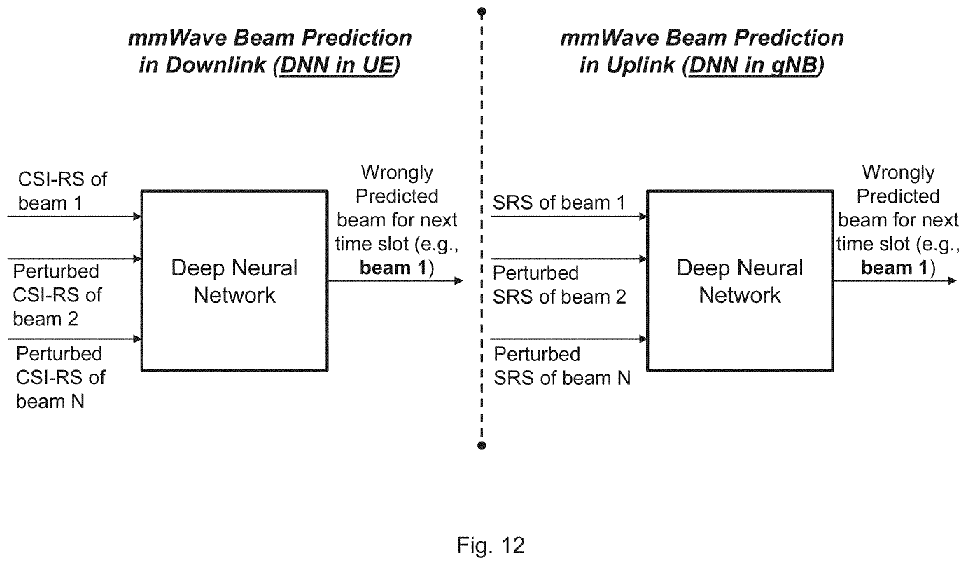

FIG. 12 shows a schematic diagram of beam selection processing according to example embodiments, and in particular illustrates Adversarial Attacks on ML-based mmWave Beam Prediction, i.e., ML-based mmWave Beam Prediction affected by Adversarial Attacks on ML-based mmWave Beam Prediction.

Namely, considering that the wireless medium is shared and open to jamming attack, an adversary can easily generate adversarial perturbations (i.e., evasion attack) to manipulate over-the-air captured CSI-RS or SRS signals that serve as input to the deep neural network(s) for mmWave beam prediction. This attack can significantly reduce the performance of mmWave beam management by fooling the deep neural network to choose/select the wrong beam (one that has poor signal quality) for the next time slot (e.g., beam 1 as illustrated in FIG. 12).

One way of defending against such an evasion attack on deep neural network(s) is to employ adversarial training where adversarial instances are generated using the gradient of the victim model and then re-training the model with the adversarial instances and their respective labels.

A specific example of AI adversarial robustness APIs offered by the AI Trust Manager (entity) to the AI Trust Engine (entity) over the T2 interface according to example embodiments as explained in general with reference to FIG. 9 is now given for the above-specified use-case example “TAI Adversarial Robustness in ML-based mmWave Beam Prediction”.

Once the AI Trust Engine (entity) sends the TAI Adversarial Robustness Capability Information Request to the AI Trust Manager (entity) of the mmWave Beam Prediction AI pipeline, the AI Trust Manager (entity) responds with the TAI Adversarial Robustness Capability Information Response. An example TAI Adversarial Robustness Capability Information Response is shown in the table below.

| Parameter | Value |
|---|---|
| CNF ID | 1 |
| >>Supported AI Adversarial Evasion | [Adversarial Training] |
| Defense Methods | |
| >>Supported AI Adversarial Poisoning | [ ] |
| Defense Methods | |
| >>Supported AI Adversarial Inference & | [Differential Privacy] |
| Inversion Defense Methods | |
| >>Supported AI Adversarial Model | [ ] |
| Extraction Defense Methods | |
| >>Supported AI Adversarial Robustness | [Empirical Robustness] |
| Metrics | |
| >>Supported AI Adversarial Robustness | [Metric Text Explainer] |
| Metric Explanations | |

Based on this response, the AI Trust Engine (entity) discovers that the mmWave Beam Prediction AI pipeline is supporting the adversarial evasion defense method “adversarial training”, the adversarial inference & inversion defense method “differential privacy”, the adversarial robustness metric “empirical robustness”, and the adversarial robustness metric explanation “metric text explainer”.

Once the AI Trust Engine (entity) discovers the TAI adversarial robustness capabilities of the mmWave Beam Prediction AI pipeline, the AI Trust Engine (entity) sends the TAI Adversarial Robustness Report Request to the AI Trust Manager (entity) of the AI pipeline. An example TAI Adversarial Robustness Report Request sent by the AI Trust Engine (entity) to the AI Trust Manager (entity) of the AI pipeline is shown in the table below. In this example, the AI Trust Engine (entity) is requesting the mmWave Beam prediction AI pipeline to report the adversarial robustness metric “empirical robustness” to determine the minimal perturbation that the adversary must introduce for a successful attack (AI Trust Engine (entity) can determine the type of attack and the type of metric to be measured based on a risk and threat analysis performed for the AI pipeline).

| Parameter | Description |
|---|---|
| CNF ID | 1 |
| >>List of AI Adversarial Robustness metrics | [Empirical Robustness] |
| >>List of AI Adversarial Robustness metric | [Metric Text Explainer] |
| explanations | |
| >>Start Time | 8:00 |
| >>End Time | 8:05 |

Once the TAI Adversarial Robustness Report Response is received, the AI Trust Engine (entity) may configure the desired AI adversarial robustness mechanisms in the mmWave Beam Prediction AI pipeline, via AI Trust Manager (entity), by means of the TAI Adversarial Robustness Configuration CRUD Request, to avoid any potential adversarial attacks. An example TAI

Adversarial Robustness Configuration CRUD Request for mmWave Beam Prediction is shown in the table below. In this example, the AI Trust Engine (entity) is requesting the AI Trust Manager (entity), to configure the adversarial robustness method “adversarial training”, the adversarial robustness metric “empirical robustness”, and the adversarial robustness metric explanation “metric text explainer”.

| Parameter | Value |
|---|---|
| CNF ID | 1 |
| >>AI Adversarial Evasion Defense Method | [Adversarial Training] |
| >>AI Adversarial Poisoning Defense Method | [ ] |
| >>AI Adversarial Inference & Inversion | [ ] |
| Defense Method | |
| >>AI Adversarial Model Extraction Method | [ ] |
| >>AI Adversarial Robustness Metrics | [Empirical Robustness] |
| >>AI Adversarial Robustness Metric | [Metric Text Explainer] |
| Explanations | |

Once the TAI adversarial robustness mechanisms are configured successfully, the AI Trust Engine (entity) may subscribe to notifications/reports from the AI Trust Manager (entity) via the TAI Adversarial Robustness Report Subscribe message. An example TAI Adversarial Robustness Report Subscribe for mmWave Beam prediction AI pipeline is shown in the table below. In this example, the AI Trust Engine (entity) is subscribing to mmWave Beam Prediction AI pipeline for reporting the adversarial robustness metric “empirical robustness” if it falls below the reporting threshold value.

| Parameter | Description |
|---|---|
| CNF ID | 1 |
| >>Applicable AI Adversarial Robustness | [Empirical Robustness] |
| metrics | |
| >>Crossed Reporting Threshold(s) | [0.2] |

The above-described procedures and functions may be implemented by respective functional elements, processors, or the like, as described below.

In the foregoing exemplary description of the network entity, only the units that are relevant for understanding the principles of the disclosure have been described using functional blocks. The network entity may comprise further units that are necessary for its respective operation. However, a description of these units is omitted in this specification. The arrangement of the functional blocks of the devices is not construed to limit the disclosure, and the functions may be performed by one block or further split into sub-blocks.

When in the foregoing description it is stated that the apparatus, i.e. network node or entity (or some other means) is configured to perform some function, this is to be construed to be equivalent to a description stating that a (i.e. at least one) processor or corresponding circuitry, potentially in cooperation with computer program code stored in the memory of the respective apparatus, is configured to cause the apparatus to perform at least the thus mentioned function. Also, such function is to be construed to be equivalently implementable by specifically configured circuitry or means for performing the respective function (i.e. the expression “unit configured to” is construed to be equivalent to an expression such as “means for”).

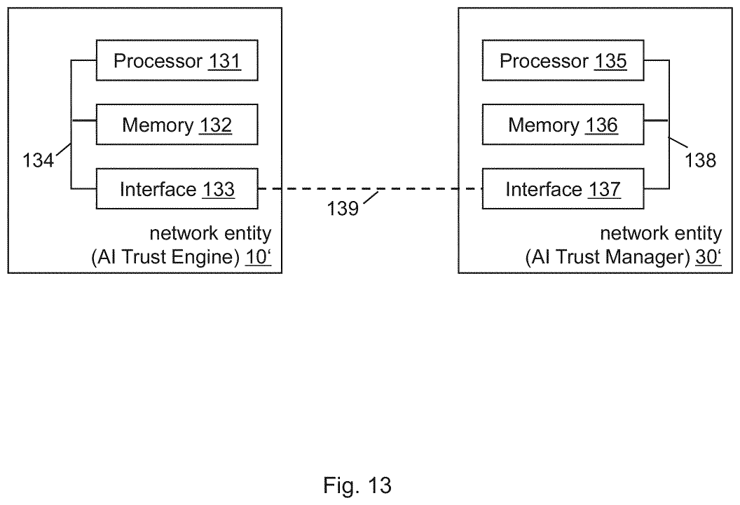

In FIG. 13, an alternative illustration of apparatuses according to example embodiments is depicted. As indicated in FIG. 13, according to example embodiments, the apparatus (network entity) 10′ (corresponding to the network entity 10) comprises a processor 131, a memory 132 and an interface 133, which are connected by a bus 134 or the like. Further, according to example embodiments, the apparatus (network entity) 30′ (corresponding to the network entity 30) comprises a processor 135, a memory 136 and an interface 137, which are connected by a bus 138 or the like, and the apparatuses may be connected via link 139, respectively.

The processor 131/135 and/or the interface 133/137 may also include a modem or the like to facilitate communication over a (hardwire or wireless) link, respectively. The interface 133/137 may include a suitable transceiver coupled to one or more antennas or communication means for (hardwire or wireless) communications with the linked or connected device(s), respectively. The interface 133/137 is generally configured to communicate with at least one other apparatus, i.e. the interface thereof.

The memory 132/136 may store respective programs assumed to include program instructions or computer program code that, when executed by the respective processor, enables the respective electronic device or apparatus to operate in accordance with the example embodiments.

In general terms, the respective devices/apparatuses (and/or parts thereof) may represent means for performing respective operations and/or exhibiting respective functionalities, and/or the respective devices (and/or parts thereof) may have functions for performing respective operations and/or exhibiting respective functionalities.

When in the subsequent description it is stated that the processor (or some other means) is configured to perform some function, this is to be construed to be equivalent to a description stating that at least one processor, potentially in cooperation with computer program code stored in the memory of the respective apparatus, is configured to cause the apparatus to perform at least the thus mentioned function. Also, such function is to be construed to be equivalently implementable by specifically configured means for performing the respective function (i.e. the expression “processor configured to [cause the apparatus to] perform xxx-ing” is construed to be equivalent to an expression such as “means for xxx-ing”).

According to example embodiments, an apparatus representing the network entity 10 (first network entity managing artificial intelligence or machine learning trustworthiness in a network) comprises at least one processor 131, at least one memory 132 including computer program code, and at least one interface 133 configured for communication with at least another apparatus. The processor (i.e. the at least one processor 131, with the at least one memory 132 and the computer program code) is configured to perform transmitting a first artificial intelligence or machine learning trustworthiness related message towards a second network entity managing artificial intelligence or machine learning trustworthiness in an artificial intelligence or machine learning pipeline in said network, wherein said first artificial intelligence or machine learning trustworthiness related message is related to artificial intelligence or machine learning model adversarial robustness as a trustworthiness sub-factor and comprises a first information element including at least one first artificial intelligence or machine learning model adversarial robustness related parameter (thus the apparatus comprising corresponding means for transmitting), and to perform receiving a second artificial intelligence or machine learning trustworthiness related message from said second network entity, wherein said second artificial intelligence or machine learning trustworthiness related message is related to artificial intelligence or machine learning model adversarial robustness as said trustworthiness sub-factor (thus the apparatus comprising corresponding means for receiving).

According to example embodiments, an apparatus representing the network entity 30 (second network entity managing artificial intelligence or machine learning trustworthiness in an artificial intelligence or machine learning pipeline in a network) comprises at least one processor 135, at least one memory 136 including computer program code, and at least one interface 137 configured for communication with at least another apparatus. The processor (i.e. the at least one processor 135, with the at least one memory 136 and the computer program code) is configured to perform receiving a first artificial intelligence or machine learning trustworthiness related message from a first network entity managing artificial intelligence or machine learning trustworthiness in said network, wherein said first artificial intelligence or machine learning trustworthiness related message is related to artificial intelligence or machine learning model adversarial robustness as a trustworthiness sub-factor and comprises a first information element including at least one first artificial intelligence or machine learning model adversarial robustness related parameter (thus the apparatus comprising corresponding means for receiving), and to perform transmitting a second artificial intelligence or machine learning trustworthiness related message towards said first network entity, wherein said second artificial intelligence or machine learning trustworthiness related message is related to artificial intelligence or machine learning model adversarial robustness as said trustworthiness sub-factor (thus the apparatus comprising corresponding means for transmitting).

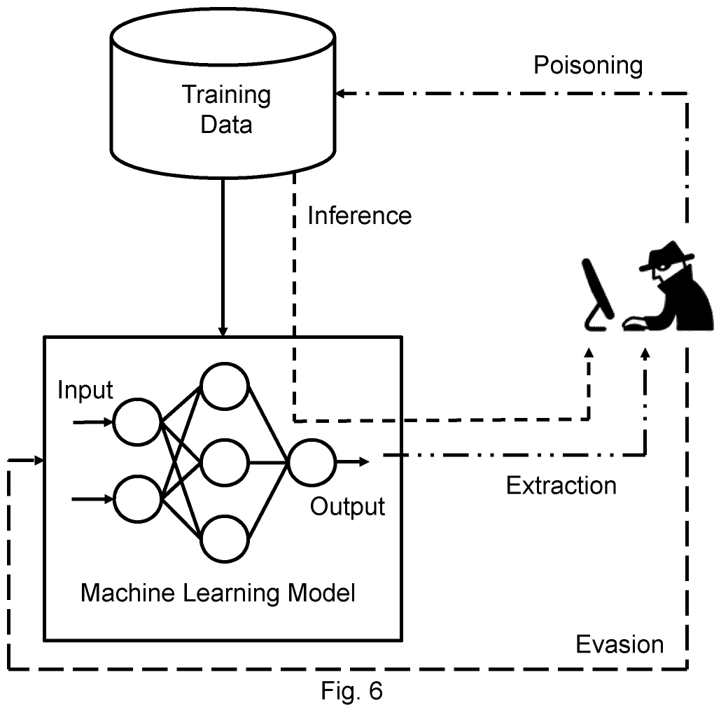

For further details regarding the operability/functionality of the individual apparatuses, reference is made to the above description in connection with any one of FIGS. 1 to 12, respectively.

For the purpose of the present disclosure as described herein above, it should be noted that
method steps likely to be implemented as software code portions and being run using a processor at a network server or network entity (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the embodiments and its modification in terms of the functionality implemented;
method steps and/or devices, units or means likely to be implemented as hardware components at the above-defined apparatuses, or any module(s) thereof, (e.g., devices carrying out the functions of the apparatuses according to the embodiments as described above) are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components;
devices, units or means (e.g. the above-defined network entity or network register, or any one of their respective units/means) can be implemented as individual devices, units or means, but this does not exclude that they are implemented in a distributed fashion throughout the system, as long as the functionality of the device, unit or means is preserved;
an apparatus like the user equipment and the network entity/network register may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present disclosure. Devices and means can be implemented as individual devices, but this does not exclude that they are implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present disclosure also covers any conceivable combination of method steps and operations described above, and any conceivable combination of nodes, apparatuses, modules or elements described above, as long as the above-described concepts of methodology and structural arrangement are applicable.

In view of the above, there are provided measures for trust related management of artificial intelligence or machine learning pipelines in relation to adversarial robustness. Such measures exemplarily comprise, at a first network entity managing artificial intelligence or machine learning trustworthiness in a network, transmitting a first artificial intelligence or machine learning trustworthiness related message towards a second network entity managing artificial intelligence or machine learning trustworthiness in an artificial intelligence or machine learning pipeline in said network, and receiving a second artificial intelligence or machine learning trustworthiness related message from said second network entity, wherein said first artificial intelligence or machine learning trustworthiness related message is related to artificial intelligence or machine learning model adversarial robustness as a trustworthiness sub-factor, said second artificial intelligence or machine learning trustworthiness related message is related to artificial intelligence or machine learning model adversarial robustness as said trustworthiness sub-factor, and said first artificial intelligence or machine learning trustworthiness related message comprises a first information element including at least one first artificial intelligence or machine learning model adversarial robustness related parameter.

Even though the disclosure is described above with reference to the examples according to the accompanying drawings, it is to be understood that the disclosure is not restricted thereto. Rather, it is apparent to those skilled in the art that the present disclosure can be modified in many ways without departing from the scope of the inventive idea as disclosed herein.

### List of Acronyms and Abbreviations

3GPP Third Generation Partnership Project
ACK acknowledgement
AI artificial intelligence
AI QOT AI quality of trustworthiness
API application programming interface
CAN cognitive autonomous network
CNF cognitive network function
CRUD creating, reading, updating and deleting
CSI-RS Channel State Information Reference Signal
DL downlink
HLEG High Level Expert Group
IE information element
MANO management and orchestration
ML machine learning
NACK non-acknowledgement
QCI QoS class identifier
QoE quality of experience
Qos quality of service
QOT quality of trustworthiness
RSRP Reference Signal Received Power
SRS Sounding Reference Signal
TAI trustworthy artificial intelligence
TAIF trustworthy artificial intelligence framework
UE user equipment
UL uplink

1-56. (canceled)

57. An apparatus of a first network entity managing artificial intelligence or machine learning trustworthiness in a network, the apparatus comprising
at least one processor,
at least one memory including computer program code, and
at least one interface configured for communication with at least another apparatus,
the at least one processor, with the at least one memory and the computer program code, being configured to cause the apparatus to perform:
transmitting a first artificial intelligence or machine learning trustworthiness related message towards a second network entity managing artificial intelligence or machine learning trustworthiness in an artificial intelligence or machine learning pipeline in said network, and
receiving a second artificial intelligence or machine learning trustworthiness related message from said second network entity, wherein
said first artificial intelligence or machine learning trustworthiness related message is related to artificial intelligence or machine learning model adversarial robustness as a trustworthiness sub-factor,
said second artificial intelligence or machine learning trustworthiness related message is related to artificial intelligence or machine learning model adversarial robustness as said trustworthiness sub-factor, and
said first artificial intelligence or machine learning trustworthiness related message comprises a first information element including at least one first artificial intelligence or machine learning model adversarial robustness related parameter.

58. The apparatus according to claim 57, wherein
said first artificial intelligence or machine learning trustworthiness related message is a trustworthiness adversarial robustness capability information request, and
said second artificial intelligence or machine learning trustworthiness related message is a trustworthiness adversarial robustness capability information response, and
said second artificial intelligence or machine learning trustworthiness related message comprises a second information element including at least one second artificial intelligence or machine learning model adversarial robustness related parameter.

59. The apparatus according to claim 58, wherein
said at least one first artificial intelligence or machine learning model adversarial robustness related parameter includes at least one of
first scope information indicative of at least one artificial intelligence or machine learning pipeline to which said trustworthiness adversarial robustness capability information request relates, and
first phase information indicative of at least one artificial intelligence or machine learning pipeline phase to which said trustworthiness adversarial robustness capability information request relates, and
said at least one second artificial intelligence or machine learning model adversarial robustness related parameter includes at least one capability entry, wherein each respective capability entry of said at least one capability entry includes at least one of
second scope information indicative of an artificial intelligence or machine learning pipeline to which said respective capability entry relates,
second phase information indicative of at least one artificial intelligence or machine learning pipeline phase to which said respective capability entry relates,
adversarial defense method information indicative of at least one adversarial defense method category including at least one category adversarial defense method, and of, for each respective category adversarial defense method, whether said respective category adversarial defense method is supported for said at least one artificial intelligence or machine learning pipeline phase of said artificial intelligence or machine learning pipeline to which said respective capability entry relates,
adversarial robustness metrics information indicative of at least one adversarial robustness metric, and of, for each respective adversarial robustness metric, whether said respective adversarial robustness metric is supported for said at least one artificial intelligence or machine learning pipeline phase of said artificial intelligence or machine learning pipeline to which said respective capability entry relates, and
adversarial robustness metric explanations information indicative of at least one adversarial robustness metric explanation, and of, for each respective adversarial robustness metric explanation, whether said respective adversarial robustness metric explanation is supported for said at least one artificial intelligence or machine learning pipeline phase of said artificial intelligence or machine learning pipeline to which said respective capability entry relates.

60. The apparatus according to claim 57, wherein
the at least one processor, with the at least one memory and the computer program code, being configured to cause the apparatus to perform:
determining, based on acquired capability information with respect to artificial intelligence or machine learning model adversarial robustness as said trustworthiness sub-factor, whether requirements related to artificial intelligence or machine learning model adversarial robustness as said trustworthiness sub-factor can be satisfied, wherein
said first artificial intelligence or machine learning trustworthiness related message is a trustworthiness adversarial robustness configuration request, and
said second artificial intelligence or machine learning trustworthiness related message is a trustworthiness adversarial robustness configuration response.

61. The apparatus according to claim 60, wherein
said at least one first artificial intelligence or machine learning model adversarial robustness related parameter includes at least one configuration entry, wherein each respective configuration entry of said at least one configuration entry includes at least one of
scope information indicative of an artificial intelligence or machine learning pipeline to which said respective configuration entry relates,
phase information indicative of at least one artificial intelligence or machine learning pipeline phase to which said respective configuration entry relates,
adversarial defense method information indicative of at least one adversarial defense method category including at least one category adversarial defense method, and of, for each respective category adversarial defense method, whether said respective category adversarial defense method is demanded for said at least one artificial intelligence or machine learning pipeline phase of said artificial intelligence or machine learning pipeline to which said respective configuration entry relates,
adversarial robustness metrics information indicative of at least one adversarial robustness metric, and of, for each respective adversarial robustness metric, whether said respective adversarial robustness metric is demanded for said at least one artificial intelligence or machine learning pipeline phase of said artificial intelligence or machine learning pipeline to which said respective configuration entry relates, and
adversarial robustness metric explanations information indicative of at least one adversarial robustness metric explanation, and of, for each respective adversarial robustness metric explanation, whether said respective adversarial robustness metric explanation is demanded for said at least one artificial intelligence or machine learning pipeline phase of said artificial intelligence or machine learning pipeline to which said respective configuration entry relates.

62. The apparatus according to claim 57, wherein
said first artificial intelligence or machine learning trustworthiness related message is a trustworthiness adversarial robustness report request, and
said second artificial intelligence or machine learning trustworthiness related message is a trustworthiness adversarial robustness report response, and
said second artificial intelligence or machine learning trustworthiness related message comprises a second information element including at least one second artificial intelligence or machine learning model adversarial robustness related parameter.

63. The apparatus according to claim 62, wherein
said at least one first artificial intelligence or machine learning model adversarial robustness related parameter includes at least one of
scope information indicative of an artificial intelligence or machine learning pipeline to which said trustworthiness adversarial robustness report request relates,
phase information indicative of at least one artificial intelligence or machine learning pipeline phase to which said trustworthiness adversarial robustness report request relates,
a list indicative of adversarial robustness metrics demanded to be reported,
a list indicative of adversarial robustness metric explanations demanded to be reported,
start time information indicative of a begin of a timeframe for which reporting is demanded with said trustworthiness adversarial robustness report request,
stop time information indicative of an end of said timeframe for which reporting is demanded with said trustworthiness adversarial robustness report request, and
periodicity information indicative of a periodicity interval with which reporting is demanded with said trustworthiness adversarial robustness report request, and
said at least one second artificial intelligence or machine learning model adversarial robustness related parameter includes at least one of
demanded adversarial robustness metrics, and
demanded adversarial robustness metric explanations.

64. The apparatus according to claim 57, wherein
said first artificial intelligence or machine learning trustworthiness related message is a trustworthiness adversarial robustness subscription, and
said second artificial intelligence or machine learning trustworthiness related message is a trustworthiness adversarial robustness notification, and
said second artificial intelligence or machine learning trustworthiness related message comprises a second information element including at least one second artificial intelligence or machine learning model adversarial robustness related parameter.

65. The apparatus according to claim 64, wherein
said at least one first artificial intelligence or machine learning model adversarial robustness related parameter includes at least one of
scope information indicative of an artificial intelligence or machine learning pipeline to which said trustworthiness adversarial robustness subscription relates,
phase information indicative of at least one artificial intelligence or machine learning pipeline phase to which said trustworthiness adversarial robustness subscription relates,
a list indicative of adversarial robustness metrics demanded to be reported,
at least one reporting threshold corresponding to at least one of said adversarial robustness metrics demanded to be reported, and
adversarial attack alarm subscription information, and
said at least one second artificial intelligence or machine learning model adversarial robustness related parameter includes
demanded adversarial robustness metrics.

66. An apparatus of a second network entity managing artificial intelligence or machine learning trustworthiness in an artificial intelligence or machine learning pipeline in a network, the apparatus comprising
at least one processor,
at least one memory including computer program code, and
at least one interface configured for communication with at least another apparatus,
the at least one processor, with the at least one memory and the computer program code, being configured to cause the apparatus to perform:
receiving a first artificial intelligence or machine learning trustworthiness related message from a first network entity managing artificial intelligence or machine learning trustworthiness in said network, and
transmitting a second artificial intelligence or machine learning trustworthiness related message towards said first network entity, wherein
said first artificial intelligence or machine learning trustworthiness related message is related to artificial intelligence or machine learning model adversarial robustness as a trustworthiness sub-factor,
said second artificial intelligence or machine learning trustworthiness related message is related to artificial intelligence or machine learning model adversarial robustness as said trustworthiness sub-factor, and
said first artificial intelligence or machine learning trustworthiness related message comprises a first information element including at least one first artificial intelligence or machine learning model adversarial robustness related parameter.

67. The apparatus according to claim 66, wherein
said first artificial intelligence or machine learning trustworthiness related message is a trustworthiness adversarial robustness capability information request, and
said second artificial intelligence or machine learning trustworthiness related message is a trustworthiness adversarial robustness capability information response, and
said second artificial intelligence or machine learning trustworthiness related message comprises a second information element including at least one second artificial intelligence or machine learning model adversarial robustness related parameter.

68. The apparatus according to claim 67, wherein
said at least one first artificial intelligence or machine learning model adversarial robustness related parameter includes at least one of
first scope information indicative of at least one artificial intelligence or machine learning pipeline to which said trustworthiness adversarial robustness capability information request relates, and
first phase information indicative of at least one artificial intelligence or machine learning pipeline phase to which said trustworthiness adversarial robustness capability information request relates, and
said at least one second artificial intelligence or machine learning model adversarial robustness related parameter includes at least one capability entry, wherein each respective capability entry of said at least one capability entry includes at least one of
second scope information indicative of an artificial intelligence or machine learning pipeline to which said respective capability entry relates,
second phase information indicative of at least one artificial intelligence or machine learning pipeline phase to which said respective capability entry relates,
adversarial defense method information indicative of at least one adversarial defense method category including at least one category adversarial defense method, and of, for each respective category adversarial defense method, whether said respective category adversarial defense method is supported for said at least one artificial intelligence or machine learning pipeline phase of said artificial intelligence or machine learning pipeline to which said respective capability entry relates,
adversarial robustness metrics information indicative of at least one adversarial robustness metric, and of, for each respective adversarial robustness metric, whether said respective adversarial robustness metric is supported for said at least one artificial intelligence or machine learning pipeline phase of said artificial intelligence or machine learning pipeline to which said respective capability entry relates, and
adversarial robustness metric explanations information indicative of at least one adversarial robustness metric explanation, and of, for each respective adversarial robustness metric explanation, whether said respective adversarial robustness metric explanation is supported for said at least one artificial intelligence or machine learning pipeline phase of said artificial intelligence or machine learning pipeline to which said respective capability entry relates.

69. The apparatus according to claim 66, wherein
said first artificial intelligence or machine learning trustworthiness related message is a trustworthiness adversarial robustness configuration request, and
said second artificial intelligence or machine learning trustworthiness related message is a trustworthiness adversarial robustness configuration response.

70. The apparatus according to claim 69, wherein
said at least one first artificial intelligence or machine learning model adversarial robustness related parameter includes at least one configuration entry, wherein each respective configuration entry of said at least one configuration entry includes at least one of
scope information indicative of an artificial intelligence or machine learning pipeline to which said respective configuration entry relates,
phase information indicative of at least one artificial intelligence or machine learning pipeline phase to which said respective configuration entry relates,
adversarial defense method information indicative of at least one adversarial defense method category including at least one category adversarial defense method, and of, for each respective category adversarial defense method, whether said respective category adversarial defense method is demanded for said at least one artificial intelligence or machine learning pipeline phase of said artificial intelligence or machine learning pipeline to which said respective configuration entry relates,
adversarial robustness metrics information indicative of at least one adversarial robustness metric, and of, for each respective adversarial robustness metric, whether said respective adversarial robustness metric is demanded for said at least one artificial intelligence or machine learning pipeline phase of said artificial intelligence or machine learning pipeline to which said respective configuration entry relates, and
adversarial robustness metric explanations information indicative of at least one adversarial robustness metric explanation, and of, for each respective adversarial robustness metric explanation, whether said respective adversarial robustness metric explanation is demanded for said at least one artificial intelligence or machine learning pipeline phase of said artificial intelligence or machine learning pipeline to which said respective configuration entry relates.

71. The apparatus according to claim 66, wherein
said first artificial intelligence or machine learning trustworthiness related message is a trustworthiness adversarial robustness report request, and
said second artificial intelligence or machine learning trustworthiness related message is a trustworthiness adversarial robustness report response, and
said second artificial intelligence or machine learning trustworthiness related message comprises a second information element including at least one second artificial intelligence or machine learning model adversarial robustness related parameter.

72. The apparatus according to claim 71, wherein
said at least one first artificial intelligence or machine learning model adversarial robustness related parameter includes at least one of
scope information indicative of an artificial intelligence or machine learning pipeline to which said trustworthiness adversarial robustness report request relates,
phase information indicative of at least one artificial intelligence or machine learning pipeline phase to which said trustworthiness adversarial robustness report request relates,
a list indicative of adversarial robustness metrics demanded to be reported,
a list indicative of adversarial robustness metric explanations demanded to be reported,
start time information indicative of a begin of a timeframe for which reporting is demanded with said trustworthiness adversarial robustness report request,
stop time information indicative of an end of said timeframe for which reporting is demanded with said trustworthiness adversarial robustness report request, and
periodicity information indicative of a periodicity interval with which reporting is demanded with said trustworthiness adversarial robustness report request, and
said at least one second artificial intelligence or machine learning model adversarial robustness related parameter includes at least one of
demanded adversarial robustness metrics, and
demanded adversarial robustness metric explanations.

73. The apparatus according to claim 66, wherein
said first artificial intelligence or machine learning trustworthiness related message is a trustworthiness adversarial robustness subscription, and
said second artificial intelligence or machine learning trustworthiness related message is a trustworthiness adversarial robustness notification, and
said second artificial intelligence or machine learning trustworthiness related message comprises a second information element including at least one second artificial intelligence or machine learning model adversarial robustness related parameter.

74. The apparatus according to claim 73, wherein
said at least one first artificial intelligence or machine learning model adversarial robustness related parameter includes at least one of
scope information indicative of an artificial intelligence or machine learning pipeline to which said trustworthiness adversarial robustness subscription relates,
phase information indicative of at least one artificial intelligence or machine learning pipeline phase to which said trustworthiness adversarial robustness subscription relates,
a list indicative of adversarial robustness metrics demanded to be reported,
at least one reporting threshold corresponding to at least one of said adversarial robustness metrics demanded to be reported, and
adversarial attack alarm subscription information, and
said at least one second artificial intelligence or machine learning model adversarial robustness related parameter includes
demanded adversarial robustness metrics.
